(19) United States
(12) Patent Application Publication
(10) Pub. No.: US 2026/0010978 A1
(43) Pub. Date: Jan. 8, 2026

(54) METHODS, DEVICES, SYSTEMS AND COMPUTER PROGRAM PRODUCTS FOR INTEGRATING STATE DATA FROM A PLURALITY OF SENSORS

(71) Applicant: Innosapien Agro Technologies Private Limited, Thane, Maharashtra (IN)

(72) Inventor: Sarang Dilip Nerkar, Thane West, Maharashtra (IN)

(21) Appl. No.: 18/007,974

(22) PCT Filed: Jun. 2, 2021
(86) PCT No.: PCT/IB2021/054821

§ 371 Date: Dec. 2, 2022

(30) Foreign Application Priority Data
Jun. 2, 2020 (IN) 202021023194

(51) Int. Cl. G06T 5/50; G06T 7/90; G06V 10/28

(52) U.S. Cl. CPC G06T 5/50; G06T 7/90; G06V 10/28; G06T 2207/10024; G06T 2207/20221

(57) ABSTRACT

The invention relates to sensor system arrangements and configurations. In particular, the invention provides methods, devices, systems and computer program products for integrating, compositing and/or processing data representing a measurable state within a region-of-interest, that has been received from a plurality of sensors that respectively have different input sensitivities, spectral sensitivity ranges and/or input capture ranges.

### CROSS-REFERENCE TO RELATED APPLICATIONS

This Application is a National Stage Application under 35 U.S.C. § 371 of PCT Application No. PCT/IB2021/054821, filed Jun. 2, 2021, which claims priority from and the benefit of Indian Patent Application number 202021023194 filed on Jun. 2, 2020, which are hereby incorporated by reference in their respective entireties.

### FIELD OF THE INVENTION

The invention relates to sensor system arrangements and configurations. In particular, the invention provides methods, devices, systems and computer program products for integrating, compositing and/or processing data representing a measurable state (for example, a physical or environmental state or condition within a region-of-interest), that has been received from a plurality of sensors that respectively have different input sensitivities, spectral sensitivity ranges and/or input capture ranges.

### BACKGROUND

A sensor is a device that detects and responds to some type of detectable input, state or state change. The specific input could be light, sound, heat, motion, moisture, pressure, or any one of a great number of other physical environmental, or detectable phenomena. At an elemental level a sensor is capable of detecting a phenomena as a point (i.e. light intensity at the point of the sensor: photoresistor, sound intensity at the point of the sensor: microphone). However, arrays of sensors could be built for measuring the phenomena over a line in one dimension (line scanning imagers) or an area in two dimensions (area scanning imagers) or a volume in three dimensions (volumetric scanning imagers).

A sensor essentially measures incoming or ambient energy in one from and converts it into another form of energy such that the output is generally a signal that is converted to human-readable display at the sensor location or transmitted electronically over a network for reading or further processing.

Energy itself exists in various forms around us such as radiant energy, thermal energy, sound energy, light energy, chemical energy, etc. Energy can be transmitted, reflected, scattered, absorbed or emitted from a medium. Energy can be converted from one form to the other. Humans experience (qualitative) or measure (quantitative) energy in various forms around them in order to understand and interpret their environment-which ability is understood as “sensing”. Human physiology includes five basic senses: sight, hearing, smell, taste and touch. These five senses allow humans to experience and interpret radiant, light, thermal, sound, chemical and kinetic energy respectively. However, owing to the respective sensory abilities and ranges within the human physiology, there is a limitation on the human ability to meaningfully sense energy around us.

For example, the human eye can adjust for vision in illumination levels between 0.0000001 lux (10⁻⁶) and 1,000,000 lux (10⁶) but the useable range within that is much less. While a maximum dynamic contrast ratio of 50 million to 1 (30 stops) is theoretically possible (i.e. from moonless overcast midnight black to the brightest sunlit white), but practically, a contrast of this range never occurs in nature—and human senses are unable to perceive that entire range at once. Human vision adjusts to light levels constantly and our static contrast ratio, which is the range that a human can visually perceive at once within a static scene, is closer to 1,000 to 1 (10 stops). This example illustrates the limitations on human visual range due to the intensity of the light energy. However, since light energy depends on the wavelength of the light, there is a spectral limitation as well (limitation due to spectral response of the human eye when compared to the environment).

FIG. 1 illustrates the spectral sensitivity of the average human eye (see the curve represented by the legend “photooptic response”) when compared to the spectral range of incoming light energy from the sun—which is ordinarily the primary source of light energy on earth during day (see the curve represented by the legend “sun”). It is apparent that the human eye is able to capture only a very small part of the actual incoming illuminating wavelengths from the sun. Likewise, comparing the spectral sensitivity of the average human eye (see the curve represented by the legend “photooptic response”) against the spectral range of illuminating wavelengths generated by a kerosene flame (see the curve represented by the legend “Kerosene Flame”). It is apparent that the human eye is able capture an even smaller part of the actual incoming illuminating wavelengths from a kerosene flame.

Similar limitations on human perception exist in case of other sensory abilities as well—for example, the dynamic range of the human ear enables humans to “hear” only a small portion of the entire audible spectrum.

Sensor technology is therefore necessary to overcome the limitations of human sensory abilities. Conventionally, sensors that are used to monitor or capture information relating to an object, article, environment or domain that is under observation, are configured to communicate with a controller or with a processor, and to transmit (to such controller or processor) state data captured by such sensors and corresponding to a detected state of the object, article, environment or domain that is under observation.

Despite significant and continuing developments in sensor technology, sensors have limitations that are similar to the limitations on human senses—i.e. sensors also have limits on the range of phenomena intensity that can sampled or captured, as well as the spectral range that can be sampled or captured. For example, a two dimensional array of light energy sensors (e.g. light sensitive sensors within a regular camera imaging sensor) has limitations on the light brightness intensities can be capture in a single two dimensional sensor output image (also known as the dynamic range of the sensor) as well as limitation on the range of wavelengths of light that the image sensor is sensitive to (also known as the wavelength spectral response band of the imaging sensor-which can be represented in the form of a curve known as the spectral response curve of the image sensor).

Unlike human sensory abilities however, the parameters and hardware/software architecture of a sensor can be altered to alter the capabilities and limitations of the sensor. For example, the photodetector material of an imaging sensor can be chosen based on the wavelength bands that are intended to be captured with the Sensor. By way of specific examples, photodetectors made of InGaAs (Indium-Gallium-Arsenide), HgCdTe (Mercury-Cadmium-Telluride) and Vox (Vanadium Oxide) can be used for sensing sensitivity in the 0.9-1.7 μm, 7-12 μm and 8-14 μm bands of the electromagnetic spectrum respectively. Similarly, one can alter camera sensor parameters such as ISO, shutter speed, aperture etc. to shift the overall range of brightness intensities captured by the sensor (increasing or decreasing the “exposure value”). In order to cover a wide range of applications the sensitivity and capabilities of a sensor need to be maximized. For instance, in order to gain a better understanding of the environment in a critical combat situation an imaging system needs to be able to capture visible, NIR and LWIR bands of the electromagnetic spectrum while maximizing the sensor's ability to capture different ranges of intensities across multiple spectral bands.

There are two ways of achieving the objective of increasing intensity capture ranges and/or overall spectral sensitivity of a sensor system. These are:
1. developing a new sensor that has much greater spectral sensitivity range and intensity capture range. This is done in various satellite payload systems that require remote sensing using various spectral bands. An example of this can be seen in FIG. 2 which illustrates the atmospheric transmission of various wavelengths of light and the spectral sensitivity bands of the Enhanced Thematic Mapper Plus (ETM+) payload of Landsat-7 satellites and Operational Land Imager (OLI) and Thermal Infrared Sensor (TIRS) payloads of Landsat-8 satellites (each of these bands is able to capture meaningful information about a specific natural phenomenon). However, development and fabrication of such sensors is an extremely expensive process and is infeasible from a commercial production standpoint (because of complex fabrication procedures and expensive material science involved). To put things into perspective the cost of making the satellite and payloads of Landsat-8 was close to USD 650 million (only accounting for fabrication costs and not including R&D costs and launch/operations costs), or
2. utilizing multiple sensors that capture the required spectral sensitivities and intensity capture ranges and creating a composite sensing apparatus that utilizes data from the multiple sensors to provide measurable state information across a wide spectral range and wide intensity capture range. While the second method is a commercially affordable way of increasing intensity capture ranges and/or overall spectral sensitivity of a sensor system, there are several challenges to being able to produce composited data which can be interpreted, processed, communicated and presented to a user in a meaningful manner.

There is accordingly a need for identifying, measuring, compositing and interpreting the influx of energy in various forms within an environment-of-interest, region-of-interest, or domain that is under observation, and to extend and overcome the spectral range and intensity capture limitations of individual sensors by meaningfully processing, representing and/or combining information extracted from signals generated by a plurality of such sensors.

### SUMMARY

The invention provides methods, devices, systems and computer program products for integrating, compositing and/or processing data representing a measurable state (for example, a physical or environmental state or condition within a region-of-interest), that has been received from a plurality of sensors that respectively have different input sensitivities, spectral sensitivity ranges and/or input capture ranges.

In an embodiment, the invention provides a method of processing sensor signals that are representative of energy incident at a sensor or a system of sensors. The method comprising implementing across one or more processors, the steps of (i) receiving an output signal from a sensor, (ii) determining based on the received output signal, a first output value, (iii) determining a second output value based on the first output value and an intensity response function associated with the sensor, (iv) determining a third output value based on the second output value and a spectral response function associated with the sensor, and (v) implementing a processing step based on the determined third output value.

In another embodiment of the method, (i) the determined second output value is representative of a quantum of discrete units of energy incident on the sensor, or (ii) the determined third output value is representative of energy incident at the sensor.

In a more specific embodiment of the method, the processing step based on the determined third output value may comprise any of a data processing step, a data presentation step, a data display step, or a step of comparing, consolidating, reconciling or compositing the third output value with any one or more other output values that have been determined based on output signal(s) received from the sensor or from one or more other sensor(s).

In a particular method embodiment, (i) the sensor is an image sensor, (ii) the determined first output value based on the output signal received from the image sensor comprises a pixel value P(i) corresponding to a pixel i within an output image received from the image sensor, (iii) the determined second output value is a PhotoQuantity value Q(i) corresponding to pixel i, wherein said PhotoQuantity value Q(i) is determined by applying an intensity response function F that is associated with the image sensor to the pixel value P(i), and (iv) the determined third output value is an EnergyQuantity value E(i) that represents energy incident at pixel i, wherein said EnergyQuantity value E(i) is determined by applying a spectral response function G that is associated with the image sensor to the PhotoQuantity value Q(i).

In a further embodiment of the method, the processing step based on the determined third output value comprises representing the EnergyQuantity value E(i) on a display device. In one embodiment of the method, representing the EnergyQuantity value E(i) on the display device comprises (i) identifying a bit depth associated with the display device, (ii) identifying a range of discrete color values capable of being represented through the identified bit depth, (iii) quantizing the EnergyQuantity value E(i) to generate a discrete color value within the range of discrete color values capable of being represented through the bit depth associated with the display, and (iv) rendering the generated discrete color value on the display device.

The invention additionally provides a method of processing sensor signals that are representative of energy incident at a plurality of sensors, the method comprising implementing across one or more processors, the steps of (i) receiving a first output signal from a first sensor, (ii) determining based on the received first output signal, a first output value, (iii) determining a second output value based on the first output value and a first intensity response function associated with the first sensor, (iv) determining a third output value based on the second output value and a first spectral response function associated with the first sensor, (v) receiving a second output signal from a second sensor, (vi) determining based on the received second output signal, a fourth output value, (vii) determining a fifth output value based on the fourth output value and a second intensity response function associated with the second sensor, (viii) determining a sixth output value based on the fifth output value and a second spectral response function associated with the second sensor, and (ix) implementing a processing step based on the determined third output value and determined sixth output value.

In an embodiment of the method, (i) the determined second output value is representative of a quantum of discrete units of energy incident on the first sensor, or (ii) the determined fifth output value is representative of a quantum of discrete units of energy incident on the second sensor, or (iii) the determined third output value is representative of energy incident at the first sensor, or (iv) the determined sixth output value is representative of energy incident at the second sensor.

In another embodiment method, the processing step based on the determined third output value and the determined sixth output value comprises any of a data processing step, a data presentation step, a data display step, or a step of comparing, consolidating, reconciling or compositing the third output value with at least the sixth output value.

In a specific embodiment of this method, (i) the first sensor is a first image sensor, (ii) the determined first output value based on the output signal received from the first image sensor comprises a first pixel value P1 (i) corresponding to a pixel i within an output image received from the first image sensor, (iii) the determined second output value is a first PhotoQuantity value Q1 (i) corresponding to the first pixel i, wherein said first PhotoQuantity value Q1 (i) is determined by applying a first intensity response function F1 that is associated with the first image sensor to the first pixel value P1 (i), and (iv) the determined third output value is an first EnergyQuantity value E1 (i) that represents energy incident at pixel i, wherein said first EnergyQuantity value Er (i) is determined by applying a first spectral response function G₁ that is associated with the first image sensor to the first PhotoQuantity value Q₁ (i).

In a particular embodiment of this method, (i) the second sensor is a second image sensor, (ii) the determined fourth output value based on the output signal received from the second image sensor comprises a second pixel value P2 (i) corresponding to a second pixel i within an output image received from the second image sensor, (iii) the determined fifth output value is a second PhotoQuantity value Q2 (i) corresponding to pixel i, wherein said second PhotoQuantity value Q2 (i) is determined by applying a second intensity response function F2 that is associated with the second image sensor to the second pixel value P2 (i), and (iv) the determined sixth output value is a second EnergyQuantity value E2 (i) that represents energy incident at the second pixel i, wherein said second EnergyQuantity value E2 (i) is determined by applying a second spectral response function G2 that is associated with the second image sensor to the second PhotoQuantity value Q2 (i).

In one embodiment of this method, the processing step based on the determined third output value and the determined sixth output value comprises representing the first EnergyQuantity value E1 (i) and the second EnergyQuantity value E2 (i) on a display device.

In a further embodiment of the method, representing the first EnergyQuantity value E1 (i) on the display device comprises (i) identifying a bit depth associated with the display device, (ii) identifying a range of discrete color values capable of being represented through the identified bit depth, (iii) quantizing the first EnergyQuantity value E1 (i) to generate a first discrete color value within the range of discrete color values capable of being represented through the bit depth associated with the display, and (iv) rendering the generated first discrete color value on the display device.

In another embodiment of the method, representing the second EnergyQuantity value E2 (i) on the display device comprises (i) quantizing the second EnergyQuantity value E₂ (i) to generate a second discrete color value within the range of discrete color values capable of being represented through the bit depth associated with the display, and (ii) rendering the generated second discrete color value on the display device.

The invention additionally provides a system for processing sensor signals that are representative of energy incident at a sensor or a system of sensors, the system comprising at least one sensor and at least one processor. The at least one processor is configured to (i) receive an output signal from the sensor, (ii) determine based on the received output signal, a first output value, (iii) determine a second output value based on the first output value and an intensity response function associated with the sensor, (iv) determine a third output value based on the second output value and a spectral response function associated with the sensor, and (v) implement a processing step based on the determined third output value.

The system may be configured such that (i) the determined second output value is representative of a quantum of discrete units of energy incident on the sensor, or (ii) the determined third output value is representative of energy incident at the sensor.

In another embodiment, the system may be configured such that the processing step based on the determined third output value comprises any of a data processing step, a data presentation step, a data display step, or a step of comparing, consolidating, reconciling or compositing the third output value with any one or more other output values that have been determined based on output signal(s) received from the sensor or from one or more other sensor(s).

In a specific embodiment, the system may be configured such that (i) the sensor is an image sensor, (ii) the determined first output value based on the output signal received from the image sensor comprises a pixel value P(i) corresponding to a pixel i within an output image received from the image sensor, (iii) the determined second output value is a PhotoQuantity value Q(i) corresponding to pixel i, wherein said PhotoQuantity value Q(i) is determined by applying an intensity response function F that is associated with the image sensor to the pixel value P(i), and (iv) the determined third output value is an EnergyQuantity value E(i) that represents energy incident at pixel i, wherein said EnergyQuantity value E(i) is determined by applying a spectral response function G that is associated with the image sensor to the PhotoQuantity value Q(i).

In a particular embodiment, the system may be configured such that the processing step based on the determined third output value comprises representing the EnergyQuantity value E(i) on a display device.

In one embodiment of the system, representing the EnergyQuantity value E(i) on the display device comprises (i) identifying a bit depth associated with the display device, (ii) identifying a range of discrete color values capable of being represented through the identified bit depth, (iii) quantizing the EnergyQuantity value E(i) to generate a discrete color value within the range of discrete color values capable of being represented through the bit depth associated with the display, and (iv) rendering the generated discrete color value on the display device.

In an alternate embodiment, the invention provides a system for processing sensor signals that are representative of energy incident at a plurality of sensors. The system comprises a plurality of sensors, and at least one processor configured to receive sensor signals from the plurality of sensors. The at least one processor is configured to (i) receive a first output signal from a first sensor, (ii) determine based on the received first output signal, a first output value, (iii) determine a second output value based on the first output value and a first intensity response function associated with the first sensor, (iv) determine a third output value based on the second output value and a first spectral response function associated with the first sensor, (v) receive a second output signal from a second sensor, (vi) determine based on the received second output signal, a fourth output value, (vii) determine a fifth output value based on the fourth output value and a second intensity response function associated with the second sensor, (viii) determine a sixth output value based on the fifth output value and a second spectral response function associated with the second sensor, and (ix) implement a processing step based on the determined third output value and determined sixth output value.

In an embodiment, the system may be configured such that (i) the determined second output value is representative of a quantum of discrete units of energy incident on the first sensor, or (ii) the determined fifth output value is representative of a quantum of discrete units of energy incident on the second sensor, or (iii) the determined third output value is representative of energy incident at the first sensor, or (iv) the determined sixth output value is representative of energy incident at the second sensor.

The system may be configured such that the processing step based on the determined third output value and the determined sixth output value comprises any of a data processing step, a data presentation step, a data display step, or a step of comparing, consolidating, reconciling or compositing the third output value with at least the sixth output value.

In another embodiment, the system may be configured such that (i) the first sensor is a first image sensor, (ii) the determined first output value based on the output signal received from the first image sensor comprises a first pixel value P1 (i) corresponding to a pixel i within an output image received from the first image sensor, (iii) the determined second output value is a first PhotoQuantity value Q1 (i) corresponding to the first pixel i, wherein said first PhotoQuantity value Q1 (i) is determined by applying a first intensity response function F1 that is associated with the first image sensor to the first pixel value P1 (i), and (iv) the determined third output value is an first EnergyQuantity value E1 (i) that represents energy incident at pixel i, wherein said first EnergyQuantity value E1 (i) is determined by applying a first spectral response function G1 that is associated with the first image sensor to the first PhotoQuantity value Q1 (i).

In a specific embodiment of the system, (i) the second sensor is a second image sensor, (ii) the determined fourth output value based on the output signal received from the second image sensor comprises a second pixel value P₂ (i) corresponding to a second pixel i within an output image received from the second image sensor, (iii) the determined fifth output value is a second PhotoQuantity value Q₂ (i) corresponding to pixel i, wherein said second PhotoQuantity value Q₂ (i) is determined by applying a second intensity response function F₂ that is associated with the second image sensor to the second pixel value P₂ (i), and (iv) the determined sixth output value is a second EnergyQuantity value E₂ (i) that represents energy incident at the second pixel i, wherein said second EnergyQuantity value E₂ (i) is determined by applying a second spectral response function G₂ that is associated with the second image sensor to the second PhotoQuantity value Q₂ (i);

In another embodiment of the system, the processing step based on the determined third output value and the determined sixth output value comprises representing the first EnergyQuantity value E1(i) and the second EnergyQuantity value E2(i) on a display device.

In an additional embodiment of the system, representing the first EnergyQuantity value E1 (i) on the display device comprises (i) identifying a bit depth associated with the display device, (ii) identifying a range of discrete color values capable of being represented through the identified bit depth, (iii) quantizing the first EnergyQuantity value E1 (i) to generate a first discrete color value within the range of discrete color values capable of being represented through the bit depth associated with the display, and (iv) rendering the generated first discrete color value on the display device.

The system may be configured such that representing the second EnergyQuantity value E2 (i) on the display device comprises (i) quantizing the second EnergyQuantity value E2 (i) to generate a second discrete color value within the range of discrete color values capable of being represented through the bit depth associated with the display, and (ii) rendering the generated second discrete color value on the display device.

In another embodiment, the invention provides a computer program product comprising a non-transitory computer readable medium having stored thereon, computer code for implementing a method of processing sensor signals that are representative of energy incident at a sensor or a system of sensors. The computer program product comprises a non-transitory computer usable medium having a computer readable program code embodied therein. The computer readable program code comprising instructions for implementing within a processor based computing system, the steps of (i) receiving an output signal from a sensor, (ii) determining based on the received output signal, a first output value, (iii) determining a second output value based on the first output value and an intensity response function associated with the sensor, (iv) determining a third output value based on the second output value and a spectral response function associated with the sensor, and (v) implementing a processing step based on the determined third output value.

In yet another embodiment, the invention provides a computer program product comprising a non-transitory computer readable medium having stored thereon, computer code for implementing a method of processing sensor signals that are representative of energy incident at a plurality of sensors. The computer program product comprises a non-transitory computer usable medium having a computer readable program code embodied therein. The computer readable program code comprises instructions for implementing within a processor based computing system, the steps of (i) receiving a first output signal from a first sensor, (ii) determining based on the received first output signal, a first output value, (iii) determining a second output value based on the first output value and a first intensity response function associated with the first sensor, (iv) determining a third output value based on the second output value and a first spectral response function associated with the first sensor, (v) receiving a second output signal from a second sensor, (vi) determining based on the received second output signal, a fourth output value, (vii) determining a fifth output value based on the fourth output value and a second intensity response function associated with the second sensor, (viii) determining a sixth output value based on the fifth output value and a second spectral response function associated with the second sensor, and (ix) implementing a processing step based on the determined third output value and determined sixth output value.

### BRIEF DESCRIPTION OF THE ACCOMPANYING DRAWINGS

FIG. 1 is a comparative graph illustrating the spectral sensitivity of the average human eye when compared to the spectral range of illumination emitted by the sun and by a kerosene flame respectively.

FIG. 2 illustrates the spectral sensitivity of a customized imaging sensor having a wide spectral sensitivity range and/or intensity capture range—for use within a satellite payload system.

FIG. 3 illustrates a typical sensor system and components therewithin.

FIGS. 4 and 5 illustrate conventional methods of compositing data from a plurality of sensors, for presentation to a user.

FIG. 6 illustrates a typical optical sensor system and components therewithin.

FIG. 7 illustrates a system for integrating and/or compositing output signals from a plurality of sensors, in accordance with the present invention.

FIG. 8 comparatively illustrates image outputs from individual image sensors as well as combined image outputs from a plurality of the individual image sensors—wherein the combined image outputs have been generated in accordance with the method of FIG. 4.

FIG. 9 comparatively illustrates image outputs from individual image sensors as well as combined image outputs from a plurality of the individual image sensors—wherein the combined image outputs have been generated in accordance with the method of FIG. 5.

FIG. 10A illustrates a method for generating, based on output values received from an individual sensor, spectral response independent and intensity response independent energy values that are representative of the energy incident at the sensor.

FIG. 10B illustrates a method for generating, based on image pixel values received from an image sensor, spectral response independent and intensity response independent energy values that are representative of the energy incident at the image sensor.

FIG. 11A illustrates a method for generating spectral response independent and intensity response independent energy values from a plurality of sensors, which values are representative of the energy incident at each such sensor—for processing or presenting data from the plurality of sensors.

FIG. 11B illustrates a method for generating, spectral response independent and intensity response independent energy values from a plurality of image sensors, based on pixel values received from each such image sensor—for processing or presenting data from the plurality of image sensors.

FIGS. 12 and 13 comparatively illustrates image outputs from individual image sensors as well as combined image outputs from a plurality of the individual image sensors—wherein the combined image outputs have been generated in accordance with teachings of the present invention.

FIG. 14 illustrates an exemplary compositing controller configured to implement the present invention.

FIG. 15 illustrates a system for integrating and/or compositing output signals from a plurality of image sensors, in accordance with the present invention.

FIG. 16 illustrates a method for displaying or presenting data corresponding to a composited output that has been generated in accordance with the present invention.

FIG. 17 illustrates an exemplary computer system according to which various embodiments of the present invention may be implemented.

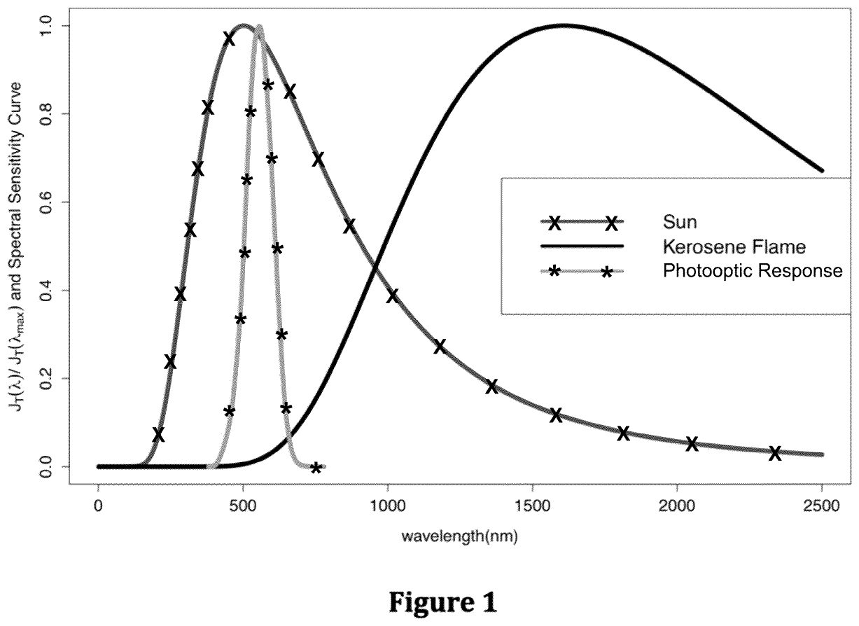

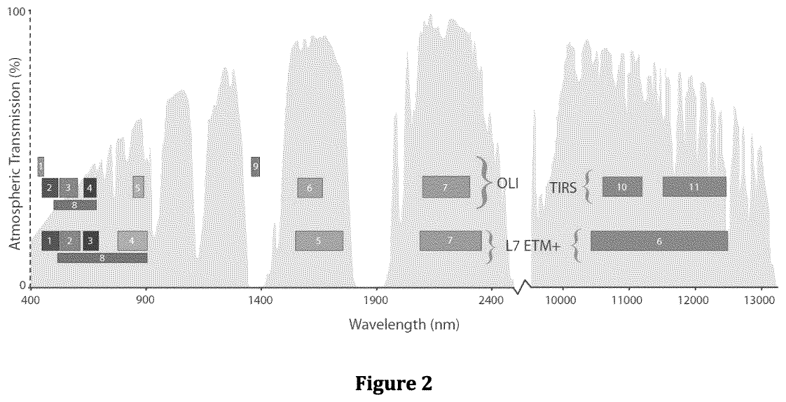

### DETAILED DESCRIPTION

The invention relates to sensor system arrangements and configurations. In particular, the invention provides methods, devices, systems and computer program products for integrating, compositing and/or processing data representing a measurable state (for example, a physical or environmental state or condition within a region-of-interest), that has been received from a plurality of sensors that respectively have different input sensitivities, spectral sensitivity ranges and/or input capture ranges.

In order to explain the method and apparatuses of the present invention (which involve multiple individual sensors configured to sense measurable states respectively based on different forms of energy) reference may be made to the configuration and operation of a typical sensor.

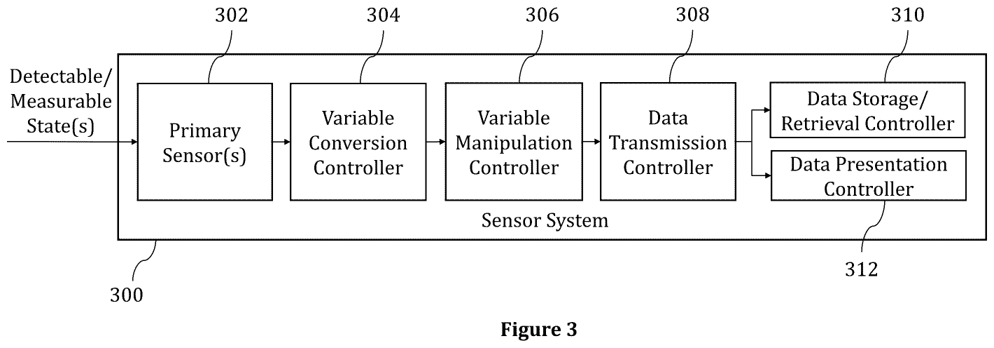

FIG. 3 illustrates a typical sensor system and components therewithin. As shown in FIG. 3, a sensor system 300 may comprise a primary sensor 302, a variable conversion controller 304, a variable manipulation controller 306, a data transmission controller 308, a data storage/data retrieval controller 310 and a data presentation controller 312. The primary sensor 302 is a sensor configured to detect one or more detectable or measurable state(s) of an object, article, environment or domain that is under observation. An example of a primary sensor 302 would in an optical sensor system comprise the imaging sensor (and optionally the optical assembly) of the optical sensor system. The output of the primary sensor(s) 302 is in the form of an electrical signal that represents information intended for control, recording and/or display.

The signal output from primary sensor(s) 302 are input to the variable conversion controller 304—wherein the variable conversion controller 304 is configured to convert the output from primary sensor(s) 302 to a desired format (for example, using filters, ADC etc.). This converted output is thereafter passed as an input to the variable manipulation controller 306—which is configured to manipulate the converted output for emphasis on desired information (for example, using amplifiers, etc.). The output from the variable manipulation controller 306 is thereafter transmitted by data transmission controller 308 to at least one of (i) the data storage/data retrieval controller 310 for storage and subsequent retrieval, and (ii) the data presentation controller 312 for display or other manner of presentation to a user/operator of the sensor system 300.

It would be understood from the above that a sensor system (which may comprise an individual sensor, or a plurality or network of sensors) does not directly measure/display an actual energy state associated with any detected state of an object, article, environment or domain that is under observation. Instead, it adjusts a signal generated in response to the energy state to a digital/analog system, and performs various physical/analog/digital conversions, manipulations and processing steps in order to bring the signal to a desired presentation format. However, each of these additional steps increasingly results in deviations between the final output signal and the original energy state detected at the primary sensor 302 within sensor system 300. As a result, existing sensor systems typically result in presentation of hypothetical/adjusted/approximated output values (for example hypothetical/adjusted/approximated output pixel values in an imaging system) which have a hypothetical meaning relative to each other when used for analysis but which do not necessarily have a direct correlation with, nor do they necessarily comprise an accurate representation of the actual energy states incident on or originally detected by a primary sensor within the sensor system. So for example, in an imaging system, the pixel values that are eventually displayed to a user/operator are not properly representative of the spectral intensity or total energy of light incident upon the image sensor within the imaging sensor. To the contrary, in traditional approaches towards sensor fusion/compositing of data from multiple sensors, the composition is mostly done in order to have a “good looking” interpretable dataset as opposed to optimizing accuracy of the dataset.

For example in order to composite and meaningfully display composited image data from an image sensing apparatus (with one lowlight near infrared (NIR) sensor and one long wavelength infrared (LWIR) sensor with greyscale outputs each) that is capable of capturing both lowlight NIR and LWIR parts of a scene the traditional approach is to somehow combine the output images of the two sensors for output through the display mechanism without necessarily taking into consideration the wavelengths and intensity of radiant energy captured by both the sensors. This approach leads to simplistic solutions of using one channel (the green channel for this example) of the display apparatus to represent the lowlight NIR data and another channel (the red channel for this example) of the display apparatus to represent the LWIR data. This approach essentially creates an imaging and display system that relies on data overlaying rather than meaningful compositing of image data—for the reason that the image processing and display apparatus has not accounted for the energy difference in the incident radiation captured by the two image sensors.

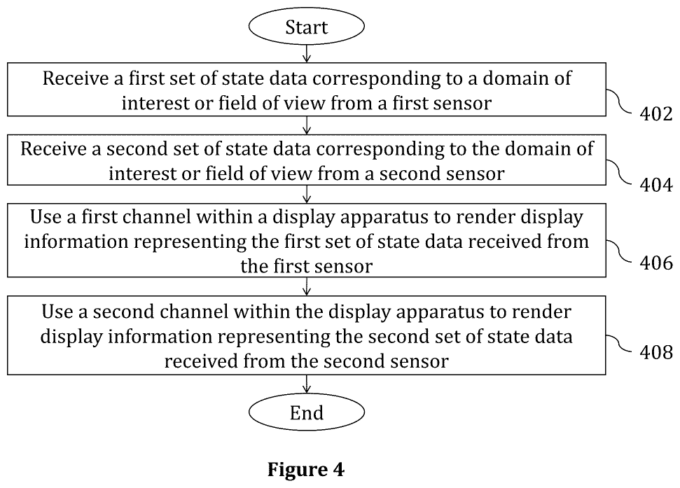

FIG. 4 illustrates the above described conventional method of compositing data from a plurality of sensors. Step 402 comprises receiving a first set of state data (for example image data) corresponding to a domain of interest or field of view from a first sensor. Step 404 comprises receiving a second set of state data (for example image data) corresponding to the same domain of interest or field of view from a second sensor. At step 406, a first channel (for example the green channel) within a display apparatus is used to render display information representing the first set of state data received from the first sensor, and at step 408 a second channel (for example the red channel within the display apparatus is used to render display information representing the second set of state data received from the second sensor.

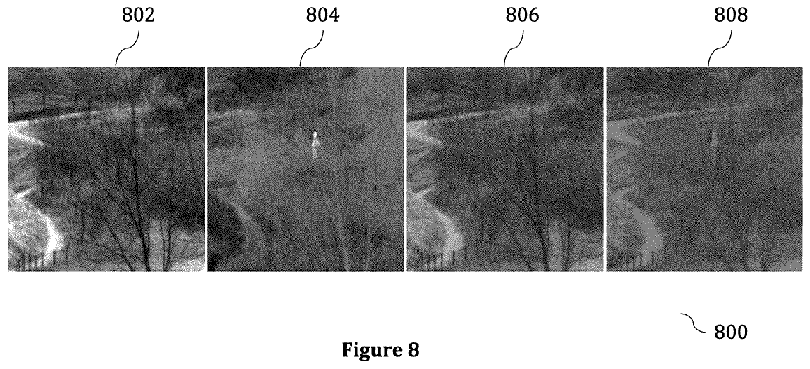

Images 802, 804 and 806 of FIG. 8 illustrate the results of using the method of FIG. 4—where image 802 is an image generated by an NIR sensitive image sensor that has captured an image of a field of view based on low light NIR wavelengths, image 804 is an image generated by an LWIR sensitive image sensor that has captured an image of a field of view based on LWIR wavelengths, and image 806 is the output rendered on a display apparatus based on the method of FIG. 4—wherein image information from the NIR sensitive image sensor is rendered using a first channel of the display and image information from the LWIR sensitive image sensor is rendered using a second channel of the display.

As shown in FIG. 8, the human figure is clearly visible in the image 804 generated by the LWIR sensitive image sensor but is not visible in the image 802 generated by NIR sensitive image sensor. In the merged image 806 generated by following the method of FIG. 4, overlaying images 802 and 804 by rendering the respective image information through different channels on the display (in image 806) appears to result in sufficiently clear rendering of the critical features of images 802 and 804—since details of both lowlight NIR and LWIR are visible in the composited image that has been rendered using the different color channels (green and red). One limitation of this traditional approach however is that it requires a multi channel display system, and would not work on monochromatic displays.

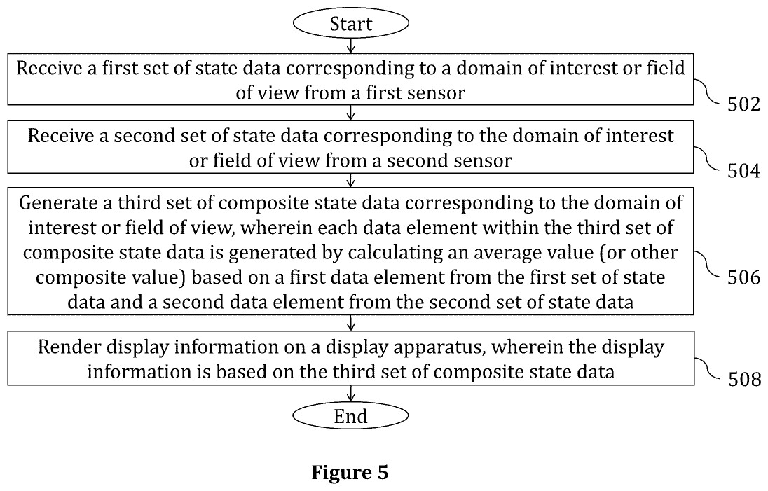

FIG. 5 illustrates an alternative method that is known for compositing and displaying composited image data from multiple sensor-which relies on generating a composite image based on “averaged” pixel values derived from pixel values of the two input images. Step 502 of FIG. 5 comprises receiving a first set of state data corresponding to an object, article, environment or domain that is under observation or that is being monitoring bya first sensor—for example, in the case where the first sensor is a first image sensor, the first set of state data comprises a first set of pixel values representing image information corresponding to the field of view of the first image sensor. Step 504 comprises receiving a second set of state data corresponding to the object, article, environment or domain that is under observation or that is being monitored, from a second sensor—for example, in the case where the second sensor is a second image sensor, the second set of state data comprises a second set of pixel values representing image information corresponding to the field of view of the second image sensor. At step 506 a third set of composite state data corresponding to the object, article, environment or domain that is under observation or that is being monitored, is generated, wherein each data element within the third set of composite state data is generated by calculating an average value (or other composite value) based on a first data element from the first set of state data and a second data element from the second set of state data. In the example, where the first sensor is a first image sensor and the second sensor is the second image sensor, the third set of composite state data comprises a third set of pixel values representing composited image information corresponding to the field of view covered by the first image sensor and the second image sensor. In said example, each data element within the third set of composite state data is a pixel value for a pixel position that is generated by calculating an average value of (i) a first pixel value for the same pixel position within the first set of pixel values, and (ii) a second pixel value for the same pixel position within the second set of pixel values. Step 508 comprises rendering display information on a display apparatus, wherein the display information is based on the third set of composite state data (i.e. on the third set of pixel values that have been generated by averaging the first and second sets of pixel values).

Images 802, 804 and 808 of FIG. 8 illustrate the results of using the method of FIG. 4—where image 802 is the image generated by an NIR sensitive image sensor that has captured an image of a field of view based on low light NIR wavelengths, image 804 is the image generated by an LWIR sensitive image sensor that has captured an image of a field of view based on LWIR wavelengths, and image 808 is the output rendered on a display apparatus based on the method of FIG. 5—wherein an average value for each pixel within the desired field of view is calculated based on a first pixel value from within image information from the NIR sensitive image sensor and a second pixel value from within image information from the LWIR sensitive image sensor, and a composited image is generated and rendered on a display based on the calculated average pixel values.

As shown in FIG. 8, the human figure is clearly visible in the image 804 generated by the LWIR sensitive image sensor but is not visible in the image 802 generated by NIR sensitive image sensor. In the merged image 808 generated by following the method of FIG. 5, generating a composited image based on averaging pixel values of the two images 802 and 804 and rendering an image 808 on a display based on the calculated average values again appears to result in a reasonably clear rendering of the critical features of images 802 and 804—and this method would also enable for display of composited images on a monochrome display, since there is no reliance on use of different color channels However, it will also be noted that the contrast and level of detail is not very high in composited image 808.

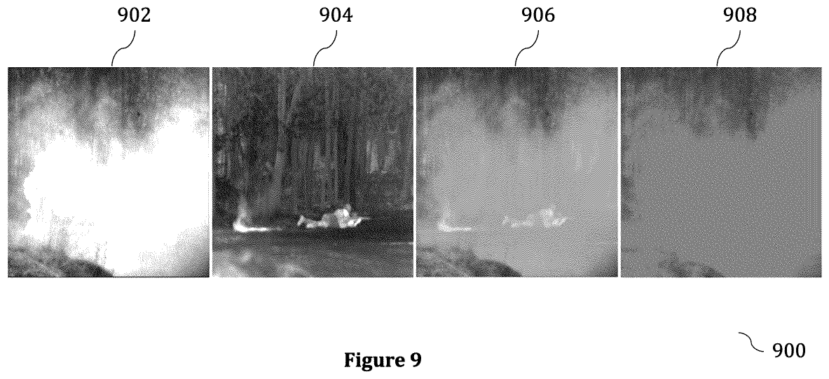

While the images 806 and 808 establish that in certain controlled circumstances, the methods of both FIGS. 4 and 5 provide reasonable results, the images 802 and 804 have been specifically selected to exclude any extreme visibility conditions/restrictions. The images of FIG. 9 on the other hand more clearly illustrate the likely drawbacks of these methods in non-controlled conditions.

Images 902, 904, 906 and 908 of FIG. 9 illustrate another set of examples of the results of using the methods of FIGS. 4 and 5—where image 902 is an image generated by an NIR sensitive image sensor that has captured an image of a field of view based on low light NIR wavelengths, image 904 is an image generated by an LWIR sensitive image sensor that has captured an image of a field of view based on LWIR wavelengths, image 906 is the output rendered on a display apparatus based on the method of FIG. 4 (wherein image information from the NIR sensitive image sensor is rendered using a first channel of the display and image information from the LWIR sensitive image sensor is rendered using a second channel of the display), and image 908 is the output rendered on a display apparatus based on the method of FIG. 5 (wherein image information from the NIR sensitive image sensor and from the LWIR sensitive image sensor are composited by calculating average pixel values based on pixel values from each image, and is thereafter rendered on a display).

Reference to images 902 to 908 establishes that despite the fact that the input sensors are the same as those used for the images of FIG. 8, the images generated based on either the methods of FIGS. 4 and 5 (images 906 and 908 respectively), are unacceptable due to loss of image information that has occurred due to the presence of extreme conditions in the scene (i.e. the presence of smoke in image 902).

It will be noted that the presence of smoke (particularly in input image 902) significantly reduces the presentability and data integrity of the image information captured by the two input image sensors 902 and 904. As established by images 906 and 908, the methods of both of FIGS. 4 and 5 fail to significantly resolve the problem-particularly since capturing of physical phenomena energy (incoming light) for producing the final composited output involves several different conversions and manipulations of image information, which alters the raw image data and causes it to lose its correlation to the actual physical environment states that such data originally represented, and also causes such data to be less meaningful (i.e. to convey less image information) to a user/viewer that is viewing the composited output of images 906 or 908.

The composited images 906 and 908 present a persuasive case for developing a new approach for compositing sensor data—wherein the compositing approach provides an output that is feasible for rendering on a monochromatic display or a color display but which also maintains the integrity of the information corresponding to the physical that has been captured by the input sensors.

The present invention surprisingly achieves this objective inter alia by reversing the inherent conversions and manipulations that have been implemented within each of the input sensors during generation of the input images—and using the image data that is output at the end of the methods for reversal to generate composited image data. The present invention also implements novel and inventive normalization techniques that transform image data from multiple sensors into normalized data that can be compared and interpreted across sensors, despite the fact that each individual sensors may have different spectral responses/spectral sensitivity and/or different intensity capture ranges.

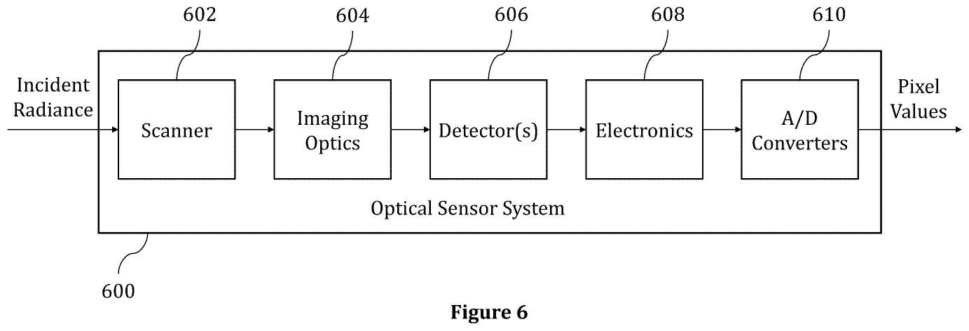

For the purposes of discussing the novel and inventive aspects of the present invention, FIG. 6 illustrates a typical optical sensor system 600 and components therewithin.

The optical sensor system 600 of FIG. 6 is a typical electro-optical sensor. Scanner 602 and imaging optics 604 are configured to implement a scanning operation that converts spatial at-sensor incident radiance to a continuous, time-varying optical signal that is received by detector(s) 606. The detector(s) 606 in turn, convert the optical signal into a continuous time-varying electronic signal, which is amplified and further processed by sensor electronics 608. Thereafter, the Analog/Digital (A/D) converter 610) samples the processed signal in time and quantized into discrete digital number values (DN values) representing the spatial image pixels.

The optical sensor system 600 operates based on the principal:

### . . . (Equation 1)

where E is the total energy received by detector(s) 606 within optical sensor system 600, n is the number of photons incident upon detector(s) 606, h is Planck's constant (6.62607015×10−34 J·s), c is the velocity of light and λ is the wavelength of the photons incident upon detector(s) 606.

As discussed above, scanner 602 and imaging optics 604 transmit incident photons to the detector(s) 606. The detector(s) 606 converts the received photons into electrical energy based on the above equation 1—thereby converting an optical signal into an electrical signal. Accordingly, the present invention implements a composite sensing mechanism that goes beyond the intensity and spectral limitations of the individual sensors/sensing mechanisms that comprise (or are part of) a multi-sensor system/multi-sensor architecture/multi-sensor infrastructure (i.e. part of a composite sensing mechanism that relies on a plurality of sensors). The invention achieves its objectives by implementing data composition processes that determines or measures the inherent energy received by the individual sensing mechanisms and process, compare, consolidate, reconcile or composite energy information representing states of energy received across multiple sensors, which can thereafter be converted to final analog/digital values for display or rendering to a user/viewer, instead of adopting the traditional approaches of generating analog/digital data state values (e.g. pixel values) and then seeking to process, compare, consolidate, reconcile or composite these analog/digital data state values across the plurality of sensors. As a result, the invention enables the data received from each of the multiple sensors to be processed in a manner such that the output of such processing accurately represent the inherent characteristics of the states that have been detected or measured by each individual sensor, despite any processing, comparing, consolidating, reconciling or compositing steps implemented on such state data.

Taking the example of the image systems of FIG. 6, theoretically, the ideal stage for retrieving or generating state data (for subsequent processing, comparing, consolidating, reconciling or compositing steps) received from multiple sensors that conform to the sensor system model of FIG. 6 would be between the imaging optics 604 and detector(s) 606. Practically however, this is impossible to achieve with conventional off-the-shelf sensor systems, since such sensor systems do not permit or enable extraction of data from the communication path between imaging optics 604 and detector(s) 606. Instead, existing sensor systems typically only enable application-based access to the final output values/final pixel values that are output by the sensor system 610. The challenge that the present invention needs to overcome is to start from the final output values/final pixel values that are output by the sensor system 610 and regenerate the data that would be passed by scanner 602 and imaging optics 604 to detector(s) 606—and to use this regenerated data as the basis for compositing of data across multiple sensors.

The present invention regenerates data by starting with output data from one or more individual sensors with a sensor system and reversing the intensity and spectral conversions and manipulations that have been implemented between detector(s) (e.g. detector(s) 606) and A/D convertor(s) (e.g. A/D convertor(s) 610)—to generate a new measurable quantity equivalent to the inherent energy incident at the detector(s) 606.

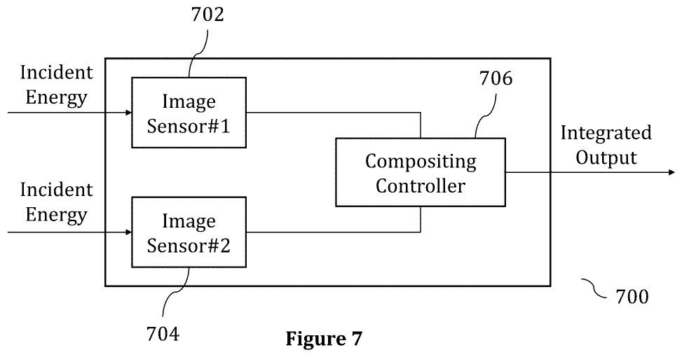

FIG. 7 illustrates a system 700 for processing (including without limitation, for comparing, consolidating, reconciling, compositing and/or integrating) output signals from a plurality of sensors, in accordance with the present invention. System 700 comprises image sensor #1 702, image sensor #2 704 and normalization controller 706. In an embodiment consistent with the imaging systems discussed above, image sensor #1 702, is a lowlight near infrared (NIR) sensor and image sensor #2 is a long wave infrared (LWIR) sensor.

For the purposes of describing the invention:
the parameter representing the total number of photons incident at an image sensor shall be referred to as “PhotoQuantity”
the parameter representing the total energy received by a sensor shall be referred to as the “EnergyQuantity” (a more detailed explanation of the term “EnergyQuantity” is provided subsequently in this written description)
the pixel value (or digital number value) of pixel i in the output image of image sensor #1 702 is P₁(i)
The PhotoQuantity of pixel i in the output image of image sensor #1 702 is Q₁(i)
The EnergyQuantity of pixel i in the output image of image sensor #1 702 is E₁(i)
the pixel value (or digital number value) of pixel i in the output image of image sensor #2 704 is P₂(i).
The PhotoQuantity of pixel i in the output image of image sensor #2 704 is Q₂(i)
The EnergyQuantity of pixel i in the output image of image sensor #2 704 is E₂(i)
The pixel value of pixel i in the output image generated by the compositing controller 706 is P_{C}(i)
The PhotoQuantity of pixel i in the output image generated by the compositing controller 706 is Q_{C}(i).
The EnergyQuantity of pixel i in the output image generated by the compositing controller 706 is E_{C}(i).
The intensity response function of the image sensor #1 702 is F₁
The spectral response function of the image sensor #1 702 is G₁.
The intensity response function of the image sensor #2 704 is F₂.
The spectral response function of the image sensor #2 704 is G₂

Referring now to the term “EnergyQuantity” the term may be understood as a quantitative measure of an energy state for an object, article, phenomena, environment or domain that is under observation-prior to the energy state being detected and quantified by a sensor). In an example where a sensor is an image sensor, the term EnergyQuantity may be understood as referring to the total energy of photons prior to said photons being collected by an imaging sensor. In the case of a sensor that is an audio sensor, EnergyQuantity may be understood as the total sound energy transmitted by an event prior to the sound waves being collected by an audio sensing mechanism.

Referring back to the method for compositing data from a plurality of sensors that is shown in FIG. 4, pixel value for each pixel i in the output image generated by a compositing controller 706 that is configured to implement the compositing method of FIG. 4, may be represented as:

$${P}_{C} ( i ) = {P}_{1} ( i ) represented through a first color channel overlayed with {P}_{2} ( i ) represented through a second color channel$$

Referring to the method for compositing data from a plurality of sensors that is shown in FIG. 5, pixel value for each pixel i in the output image generated by a compositing controller 706 that is configured to implement the compositing method of FIG. 4, may be represented as:

$${P}_{C} ( i ) = ( {P}_{1} ( i ) + {P}_{2} ( i ) ) / 2$$

In contrast, in implementing the present invention for compositing data from a plurality of sensors, energy values corresponding to each pixel i in the output image generated by a compositing controller 706 that is configured to implement the compositing method of FIG. 4, are determined and such energy values may be represented as:

$${E}_{C} ( i ) = {E}_{1} ( i ) + {E}_{2} ( i ) \qquad Equation 2 )$$

Based on the above, it would be understood that a determination of E_{C}(i) (i.e. the EnergyQuantity of pixel i in an output image generated by the compositing controller 706 is based on (i) E₁(i) (i.e. EnergyQuantity of pixel i in the output image of image sensor #1 702) and (ii) E₂(i) (i.e. EnergyQuantity of pixel i in the output image of image sensor #2 704).

EnergyQuantity E₁(i) and E₂(i) may respectively be determined in accordance with the description provided below.

PhotoQuantity Q(i) of a pixel i within an image sensor can be determined based on the intensity response function F of the image sensor and the pixel value P(i) generated by the image sensor corresponding to pixel i. More particularly the PhotoQuantity Q(i) of a pixel i within an image sensor may be equal to the output of the intensity response function F of the image sensor, to which the pixel value P(i) generated by the image sensor corresponding to pixel i has been applied as an input. Stated differently,

$$Q ( i ) = F ( P ( i ) ) \qquad ( Equation 3 )$$

Accordingly, the PhotoQuantity Q₁(i) of pixel i within the output image of image sensor #1 702 can be determined through the equation:

$${Q}_{1} ( i ) = {F}_{1} ( {P}_{1} ( i ) ) \qquad ( Equation 4 )$$

where
Q₁ (i) is the PhotoQuantity of pixel i within the output image of image sensor #1 702,
F₁ is the intensity response function of image sensor #1 702, and
(P₁ (i)) is the pixel value generated by image sensor #1 702 corresponding to pixel i.

Likewise, the PhotoQuantity Q₂(i) of pixel i within the output image of image sensor #2 704 can be determined through the equation:

$${Q}_{2} ( i ) = {F}_{2} ( {P}_{2} ( i ) ) \qquad ( Equation 5 )$$

where
Q₂ (i) is the PhotoQuantity of pixel i within the output image of image sensor #2 704,
F₂ is the intensity response function of image sensor #1 704, and
(P₂ (i)) is the pixel value generated by image sensor #2 704 corresponding to pixel i.

Thereafter, EnergyQuantity E(i) of a pixel i within an image sensor can be determined based on the spectral response function G of the image sensor and PhotoQuantity of the pixel (i). More particularly the EnergyQuantity E(i) of a pixel i within an image sensor may be equal to the output of the spectral response function G of the image sensor, to which the PhotoQuantity Q(i) corresponding to pixel i has been applied as an input. Stated differently,

$$E ( i ) = G ( Q ( i ) ) \qquad ( Equation 6 )$$

Accordingly, the EnergyQuantity E₁(i) of pixel i within the output image of image sensor #1 702 can be determined through the equation:

$${E}_{1} ( i ) = {G}_{1} ( {Q}_{1} ( i ) ) \qquad ( Equation 7 )$$

where
E₁ (i) is the EnergyQuantity of pixel i within the output image of image sensor #1 702,
G₁ is the spectral response function of image sensor #1 702, and
Q₁ (i) is the PhotoQuantity of pixel i within the output image of image sensor #1 702,

Likewise, the EnergyQuantity E₂(i) of pixel i within the output image of image sensor #2 704 can be determined through the equation:

$${E}_{2} ( i ) = {G}_{2} ( {Q}_{2} ( i ) ) \qquad ( Equation 8 )$$

where
E₂ (i) is the EnergyQuantity of pixel i within the output image of image sensor #2 704,
G₂ is the spectral response function of image sensor #2 704, and
Q₂ (i) is the PhotoQuantity of pixel i within the output image of image sensor #2 704,

By substituting the values of Equation 3 into Equation 6, the EnergyQuantity E(i) of a pixel i within an image sensor can be represented or determined as:

$$E ( i ) = G ( F ( P ( i ) ) ) \qquad ( Equation 9 )$$

where
E (i) is the EnergyQuantity of pixel i within the output image of the image sensor,
G is the spectral response function of the image sensor,
F is the intensity response function of the image sensor, and
P(i) is the PhotoQuantity of pixel i within the output image of the image sensor.

Accordingly, the EnergyQuantity E₁(i) of pixel i within the output image of image sensor #1 702 can be determined through the equation:

$${E}_{1} ( i ) = {G}_{1} ( {F}_{1} ( {P}_{1} ( i ) ) ) \qquad ( Equation 10 )$$

where
E₁(i) is the EnergyQuantity of pixel i within the output image of image sensor #1 702,
G₁ is the spectral response function of the image sensor #1 702,
F₁ is the intensity response function of the image sensor #1 702, and P₁(i) is the PhotoQuantity of pixel i within the output image of image sensor #1 702.

Likewise, the EnergyQuantity E₂(i) of pixel i within the output image of image sensor #2 704 can be determined through the equation:

$${E}_{2} ( i ) = {G}_{2} ( {F}_{2} ( {P}_{2} ( i ) ) ) \qquad ( Equation 11 )$$

where
E₂(i) is the EnergyQuantity of pixel i within the output image of image sensor #2 704,
G₂ is the spectral response function of the image sensor #2 704,
F₂ is the intensity response function of the image sensor #2 704, and
P₂(i) is the PhotoQuantity of pixel i within the output image of image sensor #2 704.

By substituting the values of Equations 10 and 11 into Equation 2, the EnergyQuantity E_{c}(i) of a pixel i within an output image that has been generated by compositing two input images (for example, an output image generated by compositing controller 706) may be determined through the equation:

$${E}_{C} ( i ) = {G}_{1} ( {F}_{1} ( {P}_{1} ( i ) ) ) + {G}_{2} ( {F}_{2} ( {P}_{2} ( i ) ) ) \qquad ( Equation 12 )$$

where
E_{c}(i) is the EnergyQuantity of a pixel i within an output image that has been generated by compositing two input images (for example, an output image generated by compositing controller 706)
G₁ is the spectral response function of the image sensor #1 702,
F₁ is the intensity response function of the image sensor #1 702,
P₁(i) is the PhotoQuantity of pixel i within the output image of image sensor #1 702,
G₂ is the spectral response function of the image sensor #2 704,
F₂ is the intensity response function of the image sensor #2 704, and
P₂(i) is the PhotoQuantity of pixel i within the output image of image sensor #2 704.

Based on the above, it would be understood that output values generated by individual sensors can be converted or normalized into spectral response independent and intensity response independent energy values that are representative of the energy incident at each of the sensors- and these energy values can be generated to rationally process, compare, consolidate, reconcile or composite outputs from individual sensors, regardless of whether the individual sensors are configured to operate within the same or different spectral ranges and/or intensity capture ranges.

For the purposes of the present invention, it would be understood that the “intensity response function” and the “spectral response function” for each sensor can be either be a function provided by the sensor manufacturer, or can be derived based on data provided by the sensor manufacturer, or can be experimentally derived. In the case of a spectral response function, the function may be derived by experimentally mapping various known spectral wavelengths to the spectral sensitivity of the sensor at those wavelengths. In the case of an intensity response function, the function may be derived by experimental mapping of data.

The intensity response function (also known as the camera response function) is the correlation between incident irradiance and irradiance sensitivity of the sensor. In the case of an imaging sensor the incident irradiance is analogous to the imaging parameters decided by the user which has been described as the exposure value and the irradiance sensitivity of the sensor is analogous to the pixel value obtained from the camera. In an embodiment, in order to experimentally derive the intensity response function, a set of experiments need to be performed where the same scene is imaged multiple times with different exposure values. This provides a set of images where the only factor different between different images is the exposure value (the scene remains exactly the same, similar to black body experiments) and hence the resulting pixel value. The different exposure values and resulting pixel values can be populated in a look up table that enables evaluation of the effect of changing the exposure value on the pixel value. For example, if the region of interest under consideration has pixel value 10 at exposure value e1 we can find out what the pixel value will be at exposure value e2 by referring to the look up table. If in one of the experiments changing exposure value from e1 to e2 changed the pixel value from 10 to 20, then it is reasonable to say that the same would happen with the region of interest under consideration, i.e. the resulting pixel value will most likely be 20. It is important to note that this type of correlation is experimental and to use this correlation, it is necessary to have a sufficient number of data points in the look up table. This experiment is then repeated with different scenes to obtain all the possible correlations to populate the look up table. This look up table serves as the intensity response function. It would additionally be understood that that the intensity response function for a sensor can be derived in accordance with any other method that would be apparent to the skilled person.

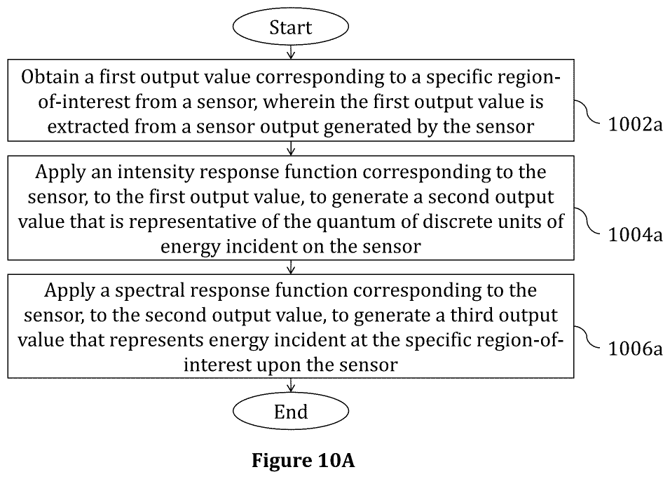

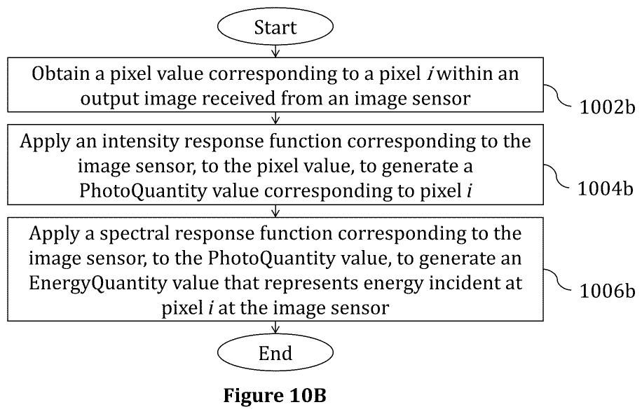

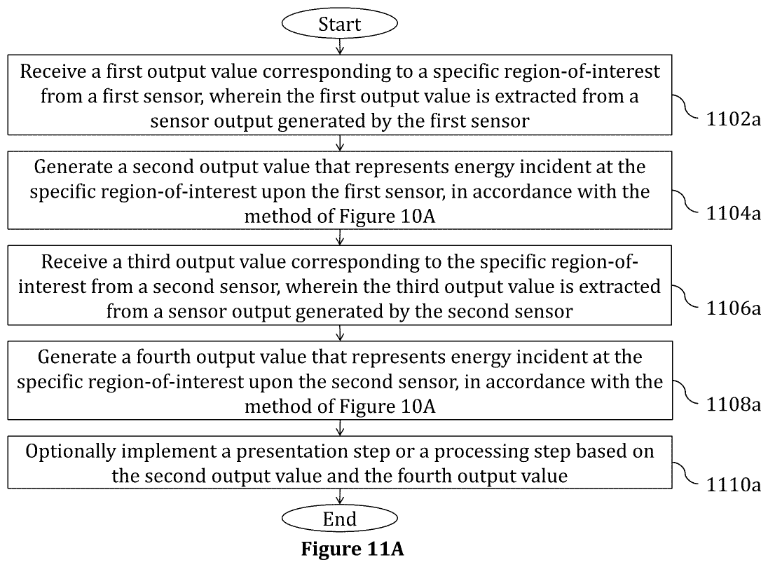

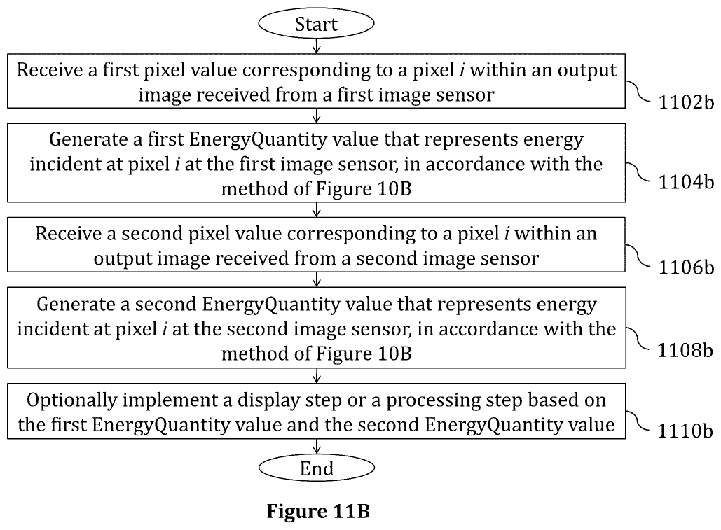

FIG. 10A illustrates a method for generating, based on output values received from a sensor, spectral response independent and intensity response independent energy values that are representative of the energy incident at the sensor.

Step 1002a comprises obtaining a first output value corresponding to a specific object, article, environment, or domain (“region-of-interest”) from a sensor, wherein the first output value is extracted from a sensor output generated by the sensor. Step 1004a comprises applying an intensity response function corresponding to the sensor, to the first output value, to generate a second output value that is representative of the quantum of discrete units of energy incident on the sensor. Step 1006a comprises applying a spectral response function corresponding to the sensor, to the second output value, to generate a third output value that represents energy incident at the specific region-of-interest upon the sensor.

FIG. 10B illustrates a method for generating, based on image pixel values received from an image sensor, spectral response independent and intensity response independent energy values that are representative of the energy incident at the image sensor.

Step 1002b comprises obtaining a pixel value P(i) corresponding to a pixel i within an output image received from an image sensor. Step 1004b comprises applying an intensity response function F corresponding to the image sensor, to the pixel value P(i), to generate a PhotoQuantity value Q(i) corresponding to pixel i. Step 1006b comprises apply a spectral response function G corresponding to the image sensor, to the PhotoQuantity value Q(i), to generate an EnergyQuantity value E(i) that represents energy incident at pixel i within the image sensor.

FIG. 11A illustrates a method for generating spectral response independent and intensity response independent energy values from a plurality of sensors, which values are representative of the energy incident at each such sensor—for processing, comparing, consolidating, reconciling, compositing or presenting data from the plurality of sensors.

Step 1102a comprises receiving a first output value corresponding to a specific region-of-interest from a first sensor, wherein the first output value is extracted from a sensor output generated by the first sensor. Step 1104a comprises generating a spectral response independent and intensity response independent second output value that represents energy incident at the specific region-of-interest upon the first sensor, in accordance with the method of FIG. 10A. Step 1106a comprises receiving a third output value corresponding to the specific region-of-interest from a second sensor, wherein the third output value is extracted from a sensor output generated by the second sensor. Step 1108a comprises generating a spectral response independent and intensity response independent fourth output value that represents energy incident at the specific region-of-interest upon the second sensor, in accordance with the method of FIG. 10A. Step 1110a comprises optionally implementing a presentation step or a processing step based on the second output value and the fourth output value. The processing step may involve any step that involves compositing, integrating, or otherwise operating on the second and fourth output values. Likewise, the presentation step may involve any step that involves presenting the second output value and/or the fourth output value and/or a composited or integrated value that is generated based on (or derived from) the second and fourth output values, to a user.

FIG. 11B illustrates a method for generating, spectral response independent and intensity response independent energy values from a plurality of image sensors, based on pixel values received from each such image sensor—for processing or presenting data from the plurality of image sensors.

Step 1102b comprises receiving a first pixel value corresponding to a pixel i within an output image received from a first image sensor. Step 1104b comprises generating a first EnergyQuantity value that represents energy incident at pixel i at the first image sensor, in accordance with the method of FIG. 10B. Step 1106b comprises receiving a second pixel value corresponding to a pixel i within an output image received from a second image sensor. Step 1108b comprises generating a second EnergyQuantity value that represents energy incident at pixel i at the second image sensor, in accordance with the method of FIG. 10B. Thereafter step 1110b comprises optionally implement a display step or a processing step based on the first EnergyQuantity value and the second EnergyQuantity value. The processing step may involve any step that involves processing, comparing, consolidating, reconciling, compositing, integrating, or otherwise operating on the first and second EnergyQuantity values. Likewise, the display step may involve any step that involves generating an output image on a display device or in any other form, wherein an image value corresponding to pixel i within the output image is based on or derived from the first EnergyQuantity value and/or the second EnergyQuantity value and/or a composited or integrated value that is generated based on (or derived from) the first and second EnergyQuantity values.

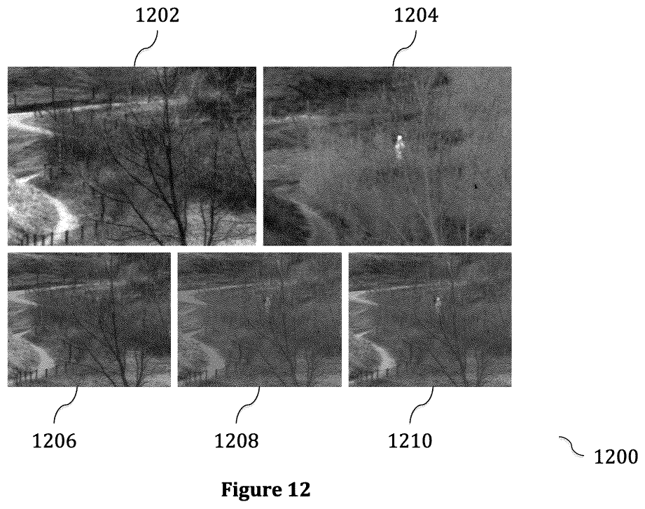

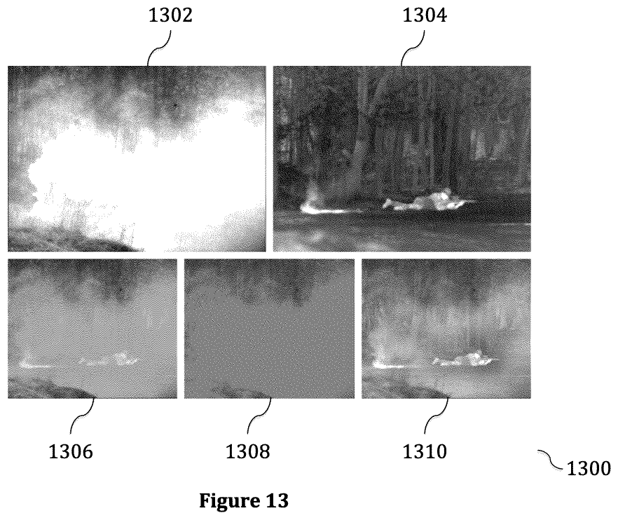

FIGS. 12 and 13 comparatively illustrates image outputs from individual image sensors as well as combined image outputs from a plurality of the individual image sensors—wherein the combined image outputs have been generated in accordance with teachings of the present invention.

Images 1202 to 1210 of FIG. 12 illustrate the comparative results of using the methods of FIGS. 4, 5 and 11B. Image 1202 is an image generated by an NIR sensitive image sensor that has captured an image of a field of view based on low light NIR wavelengths, image 1204 is an image generated by an LWIR sensitive image sensor that has captured an image of a field of view based on LWIR wavelengths. Image 1206 is the output rendered on a display apparatus based on the method of FIG. 4—wherein image information from the NIR sensitive image sensor is rendered using a first channel of the display and image information from the LWIR sensitive image sensor is rendered using a second channel of the display. Image 1208 is the output rendered on a display apparatus based on the method of FIG. 5—wherein an average value for each pixel within the desired field of view is calculated based on a first pixel value from within image information from the NIR sensitive image sensor and a second pixel value from within image information from the LWIR sensitive image sensor, and a composited image is generated and rendered on a display based on the calculated average pixel values. Image 1210 is an output image rendered on a display apparatus based on the method of FIG. 11B, which output image is based on composited or integrated EnergyQuantity values that are spectral response independent and intensity response independent energy values derived based on pixel values received from the NIR image sensor and the LWIR image sensor. A comparison of images 1206 to 1210 establishes that the composited image 1210 is capable of being displayed on a monochrome display, while clearly rendering features of images 1202 and 1204—and additionally provides better clarity and detail when compared with composited images 1206 and 1208 that have been generated in accordance with conventional methods of image compositing from a plurality of sensors.

Images 1302 to 1310 of FIG. 13 illustrate another set of comparative results of using the methods of FIGS. 4, 5 and 11B. Image 1302 is an image generated by an NIR sensitive image sensor that has captured an image of a field of view based on low light NIR wavelengths, image 1304 is an image generated by an LWIR sensitive image sensor that has captured an image of a field of view based on LWIR wavelengths. Image 1306 is the output rendered on a display apparatus based on the method of FIG. 4—wherein image information from the NIR sensitive image sensor is rendered using a first channel of the display and image information from the LWIR sensitive image sensor is rendered using a second channel of the display. Image 1308 is the output rendered on a display apparatus based on the method of FIG. 5—wherein an average value for each pixel within the desired field of view is calculated based on a first pixel value from within image information from the NIR sensitive image sensor and a second pixel value from within image information from the LWIR sensitive image sensor, and a composited image is generated and rendered on a display based on the calculated average pixel values. Image 1310 is an output image rendered on a display apparatus based on the method of FIG. 11B, which output image is based on composited or integrated EnergyQuantity values that are spectral response independent and intensity response independent energy values derived based on pixel values received from the NIR image sensor and the LWIR image sensor. A comparison of images 1306 to 1310 establishes that the composited image 1210 is capable of being displayed on a monochrome display, while clearly rendering features of images 1302 and 1304—and additionally provides significantly improved clarity and detail when compared with composited images 1306 and 1308 that have been generated in accordance with conventional methods of image compositing from a plurality of sensors. It would particularly be noted that while composited images 1306 and 1308 both suffer from unacceptable loss of image information that has occurred due to the presence of extreme conditions (presence of smoke in image 1302), composited image 1310 provides a much higher level of clarity, detail and/or accuracy than either of the composited images 1306 and 1308 that have generated in accordance with conventional methods, despite the presence of smoke in image 1302.

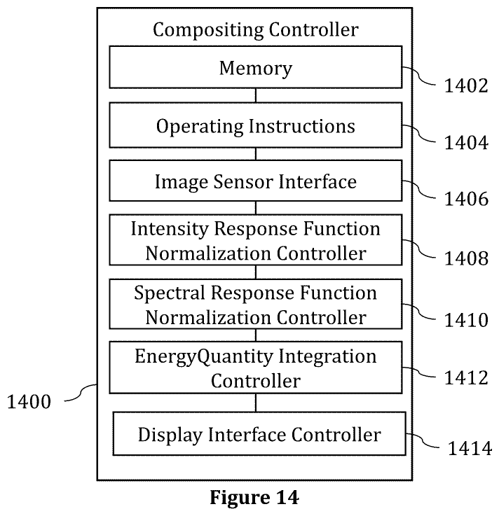

FIG. 14 illustrates an exemplary compositing controller 1400 configured to generate composite images based on a plurality of input images received from a plurality of image sensors. In an embodiment, the compositing controller 1400 is configured to implement the method of FIG. 11B described above. Compositing controller 1400 may comprise a processor implemented controller which includes (i) a memory 1402, (ii) operating instructions 1404 configured to enable compositing controller 1400 to implement the method(s) of the present invention for generating composite images, (iii) image sensor interface 1406 configured to enable compositing controller 1400 to interface with one or more image sensors and to receive image information (for example pixel value information) from each such image sensors, (iv) intensity response function normalization controller 1408 configured to receive a pixel value P(i) for a pixel i from an image sensor and apply said pixel value as input to an intensity response function F corresponding to said image sensor—to generate a PhotoQuantity value Q(i) for said pixel i, (v) spectral response function normalization controller 1410 configured to receive a PhotoQuantity Q(i) corresponding to a pixel i from intensity response function normalization controller 1408 and apply said PhotoQuantity value as input to a spectral response function G corresponding to said image sensor—to generate an EnergyQuantity value E(i) for said pixel i, (vi) EnergyQuantity integration controller 1412 configured to generate a composite EnergyQuantity value E_{c}(i) for a pixel i based on a plurality of corresponding EnergyQuantity values (E₁(i), E₂(i) . . . . Eₙ(i)) that have been generated corresponding to said pixel i based on pixel values received from a plurality of image sensors (upto n sensors) in accordance with the teachings of the present invention and (vii) display interface controller 1414 configured to generate an output image on a display—wherein each pixel value i of the output image is based on the composite EnergyQuantity value E_{c}(i) for said pixel i that has been generated by EnergyQuantity compositing controller 1412.

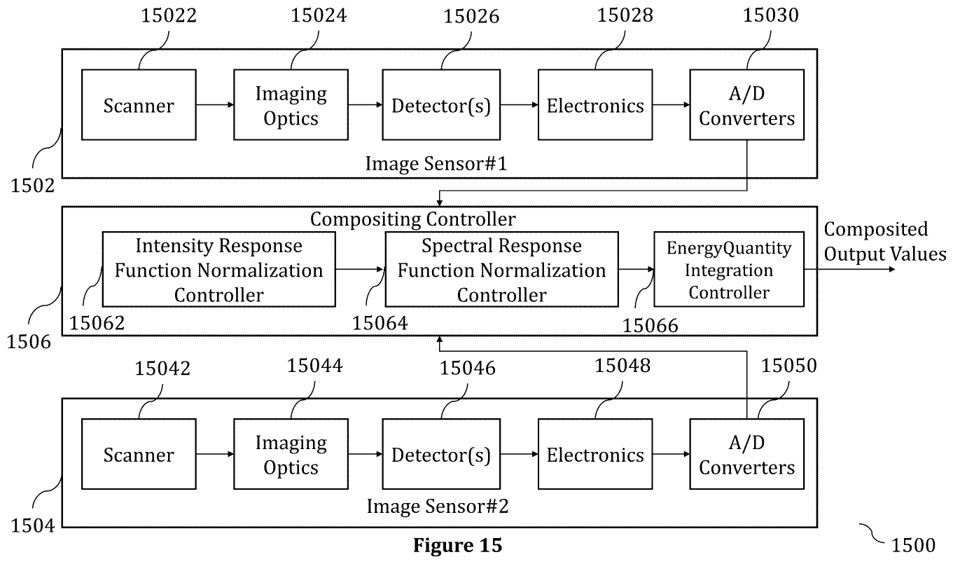

FIG. 15 illustrates a system 1500 for integrating and/or compositing output signals from a plurality of image sensors, in accordance with the present invention. The illustrated system 1500 includes at least two image sensors—image sensor #1 1502 and image sensor #2 1504. Image sensor #1 1502 comprises scanner 15022, imaging optics 15024, detector(s) 15026, electronics 15028 and A/D convertors 15030. Likewise, image sensor #2 1504 comprises scanner 15042, imaging optics 15044, detector(s) 15046, electronics 15048 and A/D convertors 15050. Each of image sensor #1 1502 and image sensor #2 1504 (and components therewithin) may be configured in accordance with the description provided above in connection with FIG. 6. Image information (for example pixel values) corresponding to images generated by each of image sensor #1 1502 and image sensor #2 1504 are passed to compositing controller 1506. Compositing controller 1506 comprises at least an intensity response function normalization controller 15062, a spectral response function normalization controller 15064 and integration controller 15066. Intensity response function normalization controller 15062 is configured to receive a pixel value P(i) for a pixel i from each image sensor 1502 and 1504 and apply said pixel value as input to an intensity response function F corresponding to the respective image sensor—to generate a PhotoQuantity value Q(i) for said pixel i. Spectral response function normalization controller 15064 is configured to receive a PhotoQuantity Q(i) corresponding to a pixel i from intensity response function normalization controller 15062 and apply said PhotoQuantity value as input to a spectral response function G corresponding to the respective image sensor—to generate an EnergyQuantity value E(i) for said pixel i. EnergyQuantity integration controller 15066 is configured to generate a composite EnergyQuantity value E_{c}(i) for a pixel i based on a plurality of corresponding EnergyQuantity values (E₁(i), E₂(i) . . . Eₙ(i)) that have been generated corresponding to said pixel i based on pixel values received from the plurality of image sensors 1502 and 1504 in accordance with the teachings of the present invention

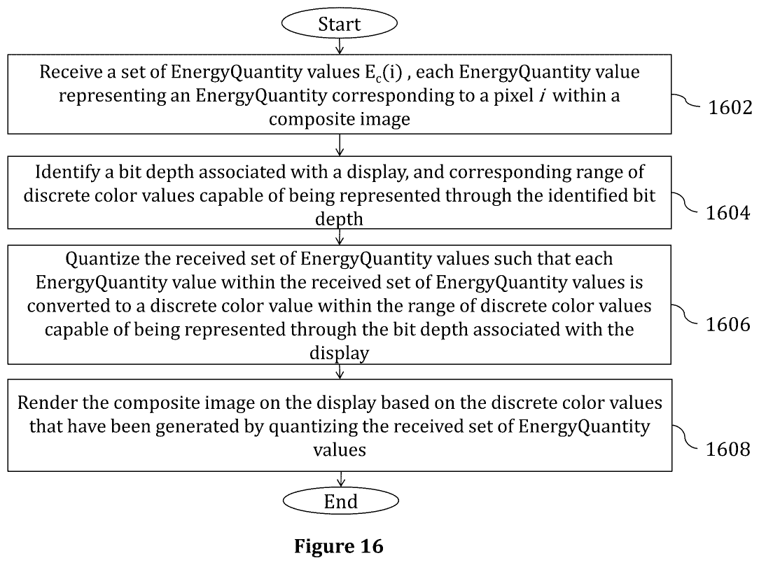

FIG. 16 illustrates a method for displaying or presenting data corresponding to a composited output that has been generated in accordance with the present invention.

Step 1602 comprises receiving a set of EnergyQuantity values E_{c}(i), each EnergyQuantity value representing an EnergyQuantity corresponding to a pixel i within a composite image (wherein said EnergyQuantity values have been generated in accordance with the teachings of the invention described above). Step 1604 comrpises Identify a bit depth associated with a display (on which the composite image is intended to be displayed), and a corresponding range of discrete color values capable of being represented through the identified bit depth. Step 1606 comprises quantizing the received set of EnergyQuantity values such that each EnergyQuantity value within the received set of EnergyQuantity values is converted to a discrete color value within the range of discrete color values capable of being represented through the bit depth associated with the display. Thereafter step 1608 comprises rendering the composite image on the display based on the discrete color values that have been generated by quantizing the received set of EnergyQuantity values.

A more detailed embodiment of the method of FIG. 16 is described hereinbelow.

As discussed above, composite EnergyQuantity values represent the total energy received by over the plurality of individual sensors from which image information is being composited together. Stated differently, composite EnergyQuantity values represent the total energy received at a virtual sensor (or fused sensor) that is a notional composite of the plurality of individual sensors from which image information is being composited. These EnergyQuantity values do not necessarily have an upper limit, for the reason that they represent the total amount of energy received in the scene. However, most conventional displays accept color values of between 0 to 255 (since they have a bit depth of 8 bits). To generate a composite image that can be displayed on a conventional display the Energy Values corresponding to individual pixels within the composite image need to be converted to values within the color values capable of being represented by the 8-bit depth.

In order to do this, the invention contemplates a sequence of method steps. The first step is identifying the highest and lowest EnergyQuantity values corresponding to the composited image. The range between the highest value and lowest value is what is required to map or convert the EnergyQuantity values to 8-bit color values. The next step involves checking whether the actual lowest EnergyQuantity value is the same as the desired lowest EnergyQuantity value that is capable of being represented within the composite image (i.e. identifying a zero value). If not, the difference (delta) between the actual lowest EnergyQuantity value and the desired lowest EnergyQuantity value, is determined. The determined delta is then subtracted from all received EnergyQuantity values corresponding to the composited image, to generate a normalized set of EnergyQuantity values corresponding to the composited image.

Thereafter a threshold value is set for the standard deviation between the pixel values of the composite image. A logarithmic compression is performed on all the EnergyQuantity values (or normalized EnergyQuantity values, if calculated) such that after the compression, said EnergyQuantity values fit in the 0-255 color value range that is capable of being displayed, and the standard deviation is less than the threshold value that has been previously set. Achieving this relies on identifying an appropriate logarithmic base for the compression—which can for example be done with a simple two sided loop of the bases. It has been observed that 2 and e(2.718) typically work best as logarithmic bases for compression, for most imaging sensors. The final values obtained after implementing the above method steps belong to the 0-255 range, are within the maximum and minimum EnergyQuantity values, have a reasonable standard deviation and hence can be displayed on a conventional display. The above process ensures that not only are the converted EnergyQuantity values within the required ranges for display, but also that the distribution of these converted EnergyQuantity values is even enough to accurately represent the composited image information on a conventional display.

While several of the embodiments of the invention discussed above are illustrated in terms of a dual sensor system—where inputs are received and integrated or composited based on two sensors, it would be understood that the teachings of the present invention can be applied for integrating or compositing any larger number of sensors as well.

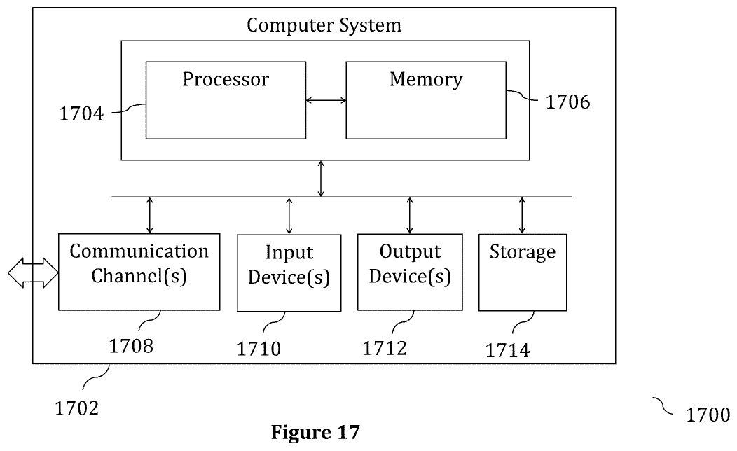

FIG. 17 illustrates an exemplary computer system 1702 which may be used to implement various embodiments of the invention as described above, including without limitation, embodiments of the normalization controller 1400 of FIG. 14 and of the normalization controller 1506 of FIG. 15.

Computer system 1702 comprises one or more processors 1704 and at least one memory 1706. Processor 1704 is configured to execute program instructions—and may be a real processor or a virtual processor. It will be understood that computer system 1702 does not suggest any limitation as to scope of use or functionality of described embodiments. The computer system 1702 may include, but is not be limited to, one or more of a general-purpose computer, a programmed microprocessor, a micro-controller, an integrated circuit, and other devices or arrangements of devices that are capable of implementing the steps that constitute the method of the present invention. Exemplary embodiments of a computer system 1702 in accordance with the present invention may include one or more servers, desktops, laptops, tablets, smart phones, mobile phones, mobile communication devices, tablets, phablets and personal digital assistants. In an embodiment of the present invention, the memory 1706 may store software for implementing various embodiments of the present invention. The computer system 1702 may have additional components. For example, the computer system 1702 may include one or more communication channels 1708, one or more input devices 1710, one or more output devices 1712, and storage 1714. An interconnection mechanism (not shown) such as a bus, controller, or network, interconnects the components of the computer system 1702. In various embodiments of the present invention, operating system software (not shown) provides an operating environment for various softwares executing in the computer system 1702 using a processor 1704, and manages different functionalities of the components of the computer system 1702.

The communication channel(s) 1708 allow communication over a communication medium to various other computing entities. The communication medium provides information such as program instructions, or other data in a communication media. The communication media includes, but is not limited to, wired or wireless methodologies implemented with an electrical, optical, RF, infrared, acoustic, microwave, Bluetooth or other transmission media.

The input device(s) 1710 may include, but is not limited to, a touch screen, a keyboard, mouse, pen, joystick, trackball, a voice device, a scanning device, or any another device that is capable of providing input to the computer system 1702. In an embodiment of the present invention, the input device(s) 1710 may be a sound card or similar device that accepts audio input in analog or digital form. The output device(s) 1712 may include, but not be limited to, a user interface on CRT, LCD, LED display, or any other display associated with any of servers, desktops, laptops, tablets, smart phones, mobile phones, mobile communication devices, tablets, phablets and personal digital assistants, printer, speaker, CD/DVD writer, or any other device that provides output from the computer system 1702.

The storage 1714 may include, but not be limited to, flash memory, chip based memory, magnetic disks, magnetic tapes, CD-ROMs, CD-RWs, DVDs, any types of computer memory, magnetic stripes, smart cards, printed barcodes or any other transitory or non-transitory medium which can be used to store information and can be accessed by the computer system 1702. In various embodiments of the present invention, the storage 1714 may contain program instructions for implementing any of the described embodiments.

In an embodiment of the present invention, the computer system 1702 is part of a distributed network or a part of a set of available cloud resources.

The present invention may be implemented in numerous ways including as a system, a method, or a computer program product such as a computer readable storage medium or a computer network wherein programming instructions are communicated from a remote location.

The present invention may suitably be embodied as a computer program product for use with the computer system 1702. The method described herein is typically implemented as a computer program product, comprising a set of program instructions that is executed by the computer system 1702 or any other similar device. The set of program instructions may be a series of computer readable codes stored on a tangible medium, such as a computer readable storage medium (storage 1714), for example, flash memory, chip based memory, diskette, CD-ROM, ROM, flash drives or hard disk, or transmittable to the computer system 1702, via a modem or other interface device, over either a tangible medium, including but not limited to optical or analogue communications channel(s) 1708. The implementation of the invention as a computer program product may be in an intangible form using wireless techniques, including but not limited to microwave, infrared, Bluetooth or other transmission techniques. These instructions can be preloaded into a system or recorded on a storage medium such as a CD-ROM, or made available for downloading over a network such as the Internet or a mobile telephone network. The series of computer readable instructions may embody all or part of the functionality previously described herein.

Based on the above, it would be apparent that the present invention offers significant advantages—in particular, by overcoming the spectral range and intensity capture limitations of individual sensors by meaningfully combining information extracted from signals generated by a plurality of such sensors and enabling meaningful processing and/or composited presentation and/or composited display of output information from the plurality of sensors without significant loss of information.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims. Additionally, the invention illustratively disclose herein suitably may be practiced in the absence of any element which is not specifically disclosed herein—and in a particular embodiment that is specifically contemplated, the invention is intended to be practiced in the absence of any one or more element which are not specifically disclosed herein.

1. A method processing sensor signals that are representative of energy incident at a sensor or a system of sensors, the method comprising implementing across one or more processors, the steps of:
receiving first output signal from a first sensor;
determining based on the received first output signal, a first output value;
determining a second output value based on the first output value and first intensity response function associated with the first sensor;
determining a third output value based on the second output value and a first spectral response function associated with the first sensor; and
implementing a processing step based on the determined third output value.

2. The method as claimed in claim 1, wherein:
the determined second output value is representative of a quantum of discrete units of energy incident on the first sensor; or
the determined third output value is representative of energy incident at the first sensor.

3. The method as claimed in claim 1, wherein the processing step based on the determined third output value comprises any of a data processing step, a data presentation step, a data display step, or a step of comparing, consolidating, reconciling or compositing the third output value with any one or more other output values that have been determined based on output signal(s) received from the first sensor or from one or more other sensor(s).

4. The method as claimed in claim 1, wherein:
the first sensor is an image sensor;
the determined first output value based on the output signal received from the image sensor comprises a pixel value P(i) corresponding to a pixel i within an output image received from the image sensor;
the determined second output value is a PhotoQuantity value Q(i) corresponding to pixel i, wherein said PhotoQuantity value Q(i) is determined by applying an intensity response function F that is associated with the image sensor to the pixel value P(i); and
the determined third output value is an EnergyQuantity value E(i) that represents energy incident at pixel i, wherein said EnergyQuantity value E(i) is determined by applying a spectral response function G that is associated with the image sensor to the PhotoQuantity value Q(i).

5. The method as claimed in claim 4, wherein the processing step based on the determined third output value comprises representing the EnergyQuantity value E(i) on a display device.

6. The method as claimed in claim 5, wherein representing the EnergyQuantity value E(i) on the display device comprises:
identifying a bit depth associated with the display device;
identifying a range of discrete color values capable of being represented through the identified bit depth;
quantizing the EnergyQuantity value E(i) to generate a discrete color value within the range of discrete color values capable of being represented through the bit depth associated with the display; and
rendering the generated discrete color value on the display device.

7. The method as claimed in claim 1, further comprising implementing across the one or more processors, the steps of:
receiving a second output signal from a second sensor;
determining based on the received second output signal, a fourth output value;
determining a fifth output value based on the fourth output value and a second intensity response function associated with the second sensor; and
determining a sixth output value based on the fifth output value and a second spectral response function associated with the second sensor;
wherein the processing step is implemented based on the determined third output value and the determined sixth output value.

8.-14. (canceled)

15. A system for processing sensor signals that are representative of energy incident at a sensor or a system of sensors, the system comprising:
at least a first sensor; and
at least one processor, wherein said at least one processor is configured to:
receive a first output signal from the first sensor;
determine based on the received first output signal, a first output value;
determine a second output value based on the first output value and first intensity response function associated with the first sensor;
determine a third output value based on the second output value and a first spectral response function associated with the first sensor; and
implement a processing step based on the determined third output value.

16. The system as claimed in claim 15, wherein:
the determined second output value is representative of a quantum of discrete units of energy incident on the first sensor; or
the determined third output value is representative of energy incident at the first sensor.

17. The system as claimed in claim 15, wherein the processing step based on the determined third output value comprises any of a data processing step, a data presentation step, a data display step, or a step of comparing, consolidating, reconciling or compositing the third output value with any one or more other output values that have been determined based on output signal(s) received from the first sensor or from one or more other sensor(s).

18. The system as claimed in claim 15, wherein:
the first sensor is an image sensor;
the determined first output value based on the output signal received from the image sensor comprises a pixel value P(i) corresponding to a pixel i within an output image received from the image sensor;
the determined second output value is a PhotoQuantity value Q(i) corresponding to pixel i, wherein said PhotoQuantity value Q(i) is determined by applying an intensity response function F that is associated with the image sensor to the pixel value P(i); and
the determined third output value is an EnergyQuantity value E(i) that represents energy incident at pixel i, wherein said EnergyQuantity value E(i) is determined by applying a spectral response function G that is associated with the image sensor to the PhotoQuantity value Q(i).

19. The system as claimed in claim 18, wherein the processing step based on the determined third output value comprises representing the EnergyQuantity value E(i) on a display device.

20. The system as claimed in claim 18, wherein representing the EnergyQuantity value E(i) on the display device comprises:
identifying a bit depth associated with the display device;
identifying a range of discrete color values capable of being represented through the identified bit depth;
quantizing the EnergyQuantity value E(i) to generate a discrete color value within the range of discrete color values capable of being represented through the bit depth associated with the display; and
rendering the generated discrete color value on the display device.

21. The system as claimed in claim 15, further comprising:
at least a second sensor;
wherein the least one processor is further configured to:
receive a second output signal from the second sensor;
determine based on the received second output signal, a fourth output value;
determine a fifth output value based on the fourth output value and a second intensity response function associated with the second sensor; and
determine a sixth output value based on the fifth output value and a second spectral response function associated with the second sensor; and
wherein the processing step is implemented based on the determined third output value and the determined sixth output value.

22.-28. (canceled)

29. A computer program product comprising a non-transitory computer readable medium having stored thereon, computer code for implementing a method of processing sensor signals that are representative of energy incident at a sensor or a system of sensors, the computer program product comprising a non-transitory computer usable medium having a computer readable program code embodied therein, the computer readable program code comprising instructions for implementing within a processor based computing system, the steps of:
receiving a first output signal from a first sensor;
determining based on the received first output signal, a first output value;
determining a second output value based on the first output value and an intensity response function associated with the first sensor;
determining a third output value based on the second output value and a first spectral response function associated with the first sensor; and
implementing a processing step based on the determined third output value.

30. (canceled)
